(19) United States
(12) Patent Application Publication
(10) Pub. No.: US 2025/0014275 A1
(43) Pub. Date: Jan. 9, 2025

(54) CONTROL METHOD, DETECTION DEVICE, MOVABLE PLATFORM, AND COMPUTER-READABLE STORAGE MEDIUM

(71) Applicant: SZ DJI TECHNOLOGY CO., LTD., Shenzhen (CN)

(72) Inventors: Yalin CHEN, Shenzhen (CN); Li WANG, Shenzhen (CN); Xiao HUANG, Shenzhen (CN); Xiaobing XIE, Shenzhen (CN)

(21) Appl. No.: 18/896,707

(22) Filed: Sep. 25, 2024

Related U.S. Application Data
(63) Continuation of application No. PCT/CN2022/083266, filed on Mar. 28, 2022.

(51) Int. Cl. G06T 17/00; G01S 17/89

(52) U.S. Cl. CPC G06T 17/00; G01S 17/89

(57) ABSTRACT

A control method includes obtaining distribution information of a point cloud obtained by a detection device. The detection device includes a light source, and a first reflection assembly and a second reflection assembly configured to cause a light beam emitted by the light source to scan in a first direction and a second direction, respectively, to obtain the point cloud in a detection range. The method further includes, in response to a point cloud line distribution of the point cloud deviating from the second direction, controlling the first reflection assembly to adjust from a current attitude to a target attitude, to correct the point cloud line distribution to the second direction.

### CROSS-REFERENCE TO RELATED APPLICATION

This application is a continuation of International Patent Application No. PCT/CN2022/083266, filed on Mar. 28, 2022, the entire content of which is incorporated herein by reference.

### TECHNICAL FIELD

The present disclosure generally relates to the field of detection technology, and, more particularly, to a control method, a detection device, a movable platform, and a computer-readable storage medium.

### BACKGROUND

A detection device such as a LiDAR can scan a scene within a detection range by emitting a sequence of light pulses, such that point cloud corresponding to the scene can be collected. By analyzing the point cloud corresponding to the scene, relevant information of the scene can be obtained to achieve perception of the environment. One metric for evaluating point cloud data is point cloud uniformity which can characterize the consistency of point cloud density in space. In most applications, the higher the uniformity of the LiDAR point cloud, the lower the probability of missing small-sized objects during measurement.

At present, the industry often obtains a point cloud distribution with multiple point cloud rows through multi-line LiDAR scanning. The uniform distribution of point cloud rows means that in different areas, the difference in point cloud density of the LiDAR point cloud in different areas is small, and the uniformity is high. However, the working condition of the detection device will affect the uniformity of the point cloud distribution, such that the expected point cloud distribution cannot be obtained.

### SUMMARY

In accordance with the disclosure, there is provided a control method including obtaining distribution information of a point cloud obtained by a detection device. The detection device includes a light source, and a first reflection assembly and a second reflection assembly configured to cause a light beam emitted by the light source to scan in a first direction and a second direction, respectively, to obtain the point cloud in a detection range. The method further includes, in response to a point cloud line distribution of the point cloud deviating from the second direction, controlling the first reflection assembly to adjust from a current attitude to a target attitude, to correct the point cloud line distribution to the second direction.

Also in accordance with the disclosure, there is provided a detection device including a light source configured to emit a sequence of light pulses, a first reflection assembly and a second reflection assembly configured to cause a light beam emitted by the light source to scan in a first direction and a second direction, respectively, to obtain a point cloud within a detection range, at least one processor, and at least one memory storing at least one computer program that, when executed by the at least one processor, causes the detection device to obtain distribution information of the point cloud, and, in response to a point cloud line distribution of the point cloud deviating from the second direction, control the first reflection assembly to adjust from a current attitude to a target attitude, to correct the point cloud line distribution to the second direction.

Also in accordance with the disclosure, there is provided a movable platform including a movable platform body, and a detection device mounted at the movable platform body and including a light source configured to emit a sequence of light pulses, and a first reflection assembly and a second reflection assembly configured to cause a light beam emitted by the light source to scan in a first direction and a second direction, respectively, to obtain a point cloud within a detection range. The movable platform further includes at least one processor, and at least one memory storing at least one computer program that, when executed by the at least one processor, causes the detection device to obtain distribution information of the point cloud, and, in response to a point cloud line distribution of the point cloud deviating from the second direction, control the first reflection assembly to adjust from a current attitude to a target attitude, to correct the point cloud line distribution to the second direction.

### BRIEF DESCRIPTION OF THE DRAWINGS

FIG. 1 is a flowchart of a control method consistent with the present disclosure.

FIG. 2 is a schematic structural diagram of a detection device consistent with the present disclosure.

FIG. 3 is a schematic structural diagram of a first reflection assembly consistent with the present disclosure.

FIG. 4 is a schematic structural diagram of a second reflection assembly consistent with the present disclosure.

FIG. 5 is a schematic diagram of a point cloud frame consistent with the present disclosure.

FIG. 6 is a schematic structural diagram of another second reflection assembly consistent with the present disclosure.

FIG. 7 is a schematic diagram of a point cloud frame obtained through scanning of a second reflection assembly consistent with the present disclosure.

FIG. 8 is a flowchart of another control method consistent with the present disclosure.

FIG. 9 is a flowchart of another control method consistent with the present disclosure.

FIG. 10 is a schematic structural diagram of another detection device consistent with the present disclosure.

FIG. 11 is a schematic structural diagram of a movable platform consistent with the present disclosure.

FIG. 12 is a schematic structural diagram of another movable platform consistent with the present disclosure.

### DETAILED DESCRIPTION OF THE EMBODIMENTS

Specific embodiments of the present disclosure are hereinafter described with reference to the accompanying drawings. The same or similar reference numbers represent the same or similar elements or elements with the same or similar functions. The described embodiments are merely examples of the present disclosure, but not all of embodiments provided by the present disclosure. The described embodiments should not be regarded as limiting, but are merely examples. Those skilled in the art will envision other modifications within the scope and spirit of the present disclosure.

In the present disclosure, the terms “first” and “second” are only used for descriptive purposes and cannot be understood as indicating or implying the relative importance or implicitly indicating the quantity of the indicated technical features. Features associated with “first” and “second” may explicitly or implicitly include one or more of the described features. In the present disclosure, “plurality” means two or more, unless otherwise expressly and specifically limited.

In the present disclosure, unless otherwise clearly stated and limited, the terms “installation” or “connection” should be understood in a broad sense. For example, it may be a fixed connection, a detachable connection, or a connection in one piece. The connection may be mechanical or electrical. The connection may be a direct connection or an indirect connection through an intermediary. It can be an internal connection between two elements or an interaction between two elements. For those of ordinary skill in the art, the specific meanings of the above terms in the present disclosure can be understood according to specific circumstances.

The following disclosure provides many different embodiments or examples for implementing the various structures of the present disclosure. To simplify the description of the present disclosure, the components and arrangements of specific examples are described below. Of course, they are merely examples and are not intended to limit the scope of the present disclosure. Further, the reference numbers and/or reference letters may be repeated in different examples. Such repetition is for the purposes of simplicity and clarity and does not by itself indicate a relationship between the various embodiments and/or arrangements discussed. In addition, the present disclosure provides examples of various specific processes and materials, but those of ordinary skill in the art will recognize the application of other processes and/or the use of other materials.

A detection device such as a LiDAR is a perception system that uses lasers to scan and measure distances to obtain three-dimensional information in the surrounding scene. The basic principle is to actively emit laser pulses to the detected object, capture the laser echo signal, and calculate the distance of the detected object based on the time difference between laser emission and reception. Through high-frequency emission and reception, the distance information and angle information of a large number of detection points may be obtained, which is called a point cloud. Based on the point cloud, the three-dimensional information of the surrounding scene may be reconstructed. One of the key metrics of the LiDAR is the density of the point cloud (also referred to as point cloud density in the present disclosure), which can be defined as the number of points in a unit three-dimensional space. Generally speaking, in the same time, when the point cloud density of the LiDAR is higher, the resolution and efficiency of its three-dimensional measurement is higher. Another key metric of the LiDAR is the uniformity of the point cloud (also referred to as point cloud uniformity in the present disclosure), which can characterize the consistency of the point cloud density in space. When the difference in point cloud density in different areas of the LiDAR is smaller, its uniformity may be higher. In most applications, when the uniformity of the LiDAR point cloud is higher, the probability of missing small-sized objects during measurement may be lower.

At present, the commonly used LiDARs in the industry are usually multi-line scanning LiDARs, and the common multi-line scanning LiDARs are 16, 32, 40, or 64 lines. A multi-line scanning LiDAR can obtain multiple laser scanning lines through scanning, thereby obtaining point cloud distribution. Usually, to obtain a larger scanning range, the LiDAR will set up multiple reflection assemblies, and use the rotation of the reflection assemblies to make the light pulses emit at different angles to reach different areas within the detection range. However, if a reflection assembly fails, it may change the desired optical path and the emission angle of the light pulse, resulting in abnormal point cloud distribution and deviation from expectations. Because of the high cost of LiDAR and time-consuming and labor-intensive installation and debugging, replacing the entire LiDAR or replacing the reflection assembly is not the best solution.

One aspect of the present disclosure provides a control method of a detection device. When a problem occurs in one reflection assembly causing abnormal point cloud distribution, the control method may use other reflection assemblies to adjust the point cloud distribution, to obtain a desired point cloud distribution.

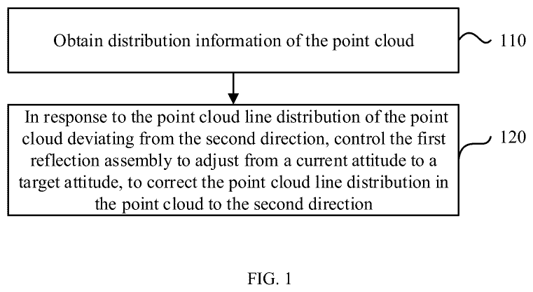

As shown in FIG. 1, in one embodiment, the method includes:
110: obtaining distribution information of a point cloud; and
120: determine whether a point cloud line distribution of the point cloud is along a second direction, and, if the point cloud line distribution of the point cloud deviates from the second direction, controlling a first reflection assembly to adjust from a current attitude to a target attitude, to correct the point cloud line distribution in the point cloud to the second direction.

In one embodiment, the detection device may include a light source, a first reflection assembly, and a second reflection assembly. The light pulse emitted by the light source may be reflected by the first reflection assembly and the second reflection assembly in turn. The first reflection assembly may make the light pulse emit at different angles in the first direction, and then the light pulse may reach the second reflection assembly. The second reflection assembly may make the light pulse emit at different angles in the second direction. Therefore, the light pulse emitted by the light source may be scanned in the first direction and the second direction respectively to obtain the point cloud within the detection range.

In one embodiment, the point cloud information of the detection range may usually be obtained by a processing device. After obtaining the distribution information of the point cloud detected by the detection device, the processing device may assess the point cloud distribution, to determine whether the point cloud distribution has a distribution anomaly caused by the working condition of the detection device. For example, the processing device may assess the point cloud line distribution in the point cloud. When the point cloud line distribution of the point cloud deviates from the second direction, it may be indicated that the second reflection assembly is abnormal, and the light pulse passing through the second reflection assembly cannot scan the detection range along the predetermined second direction. Therefore, the reflection assembly may need to be adjusted.

When the point cloud line distribution of the point cloud deviates from the second direction, the first reflection assembly may be controlled to adjust from the current attitude to the target attitude, to correct the point cloud line distribution in the point cloud to the second direction. Because the light pulse reaches the second reflection assembly after being reflected by the first reflection assembly, the angle and direction of the light pulse after being reflected by the first reflection assembly may be changed by adjusting the first reflection assembly. After the light pulse reaches the second reflection assembly, there may be a new reflection path, so there may be a chance to adjust the light pulse reflected by the second reflection assembly to the desired direction. In this way, even when the second reflection assembly works abnormally, it may be not necessary to replace the second reflection assembly or replace the entire detection device. By adjusting the working state of the first reflection assembly, the detection device may be corrected, which greatly reduces the maintenance and replacement cost of the detection device, and is conducive to the large-scale promotion and use of the detection device.

In one embodiment, the current attitude of the first reflection assembly may be the first reflection assembly being at the current position, and the target attitude of the first reflection assembly may be the first reflection assembly being at the target position. At the target position, the light pulse may be emitted along the second direction after being reflected by the first reflection assembly and the second reflection assembly.

In one embodiment, controlling the first reflection assembly to adjust from the current attitude to the target attitude may include controlling the first reflection assembly to adjust from the current position to the target position. When there is no abnormality in the second reflection assembly, the light pulse should be along the desired second direction after being reflected by the first reflection assembly and the second reflection assembly. Therefore, when the point cloud line distribution of the point cloud deviates from the second direction, controlling the first reflection assembly to adjust from the current attitude to the target attitude may correct the point cloud line distribution in the point cloud to the second direction.

In one embodiment, the first direction may be a vertical direction, and correspondingly, the second direction may be a horizontal direction.

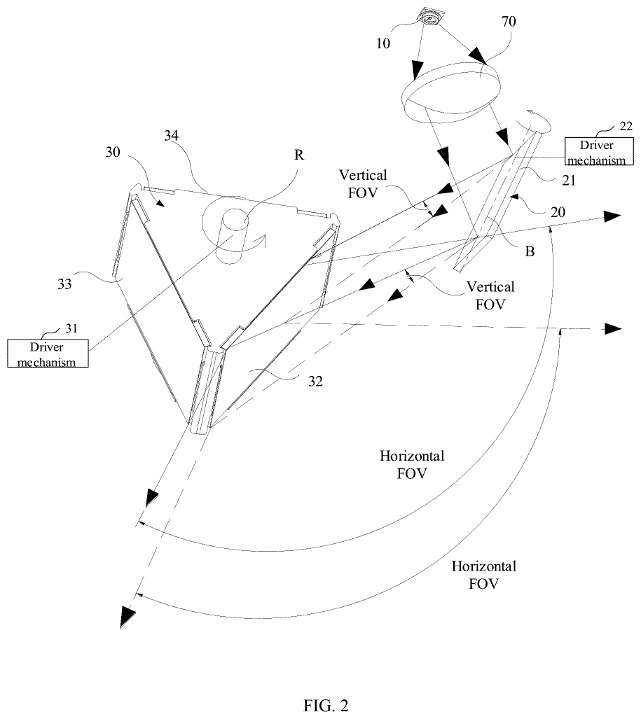

FIG. 2 is a schematic structural diagram of a detection device provided by one embodiment of the present disclosure. As shown in FIG. 2, in one embodiment, the detection device 100 may include a light source 10, a first reflection assembly 20, and a second reflection assembly 30. The light source 10 may emit a sequence of light pulses, and the first reflection assembly 20 and the second reflection assembly 30 may be sequentially arranged at the optical path of the light pulses, such that the light beam emitted by the light source 10 is able to reach a certain position in the detection range after being reflected by the first reflection assembly 20 and the second reflection assembly 30. The first reflection assembly 10 may be configured to scan the light beam in the first direction, and the second reflection assembly 30 may be configured to scan the light beam in the second direction, such that the point cloud distribution within the detection range may be obtained.

In one embodiment, the first direction may be the vertical direction, and the second direction may be the horizontal direction. The first reflection assembly 20 may be able to rotate under the drive of a driver mechanism 22, such that the light beam reflected by the first reflection assembly 20 is emitted at different vertical angles and a vertical scan of the detection range is achieved. Therefore, the detection device may have a vertical field of view (FOV). The vertical angle may be the angle between the emission direction of the light beam and the horizontal plane. The second reflection assembly 30 may rotate under the drive of a driver mechanism 31, such that the light beam reflected by the second reflection assembly 30 is emitted at different horizontal angles to form a horizontal scan of the detection range, thereby obtaining a horizontal FOV. Through the cooperation of the first reflection assembly and the second reflection assembly, the sequence of light pulses emitted by the light source may be able to cover the entire detection range, such that the point cloud corresponding to the scene in the detection range is able to be collected.

In one embodiment, the first reflection assembly may include a first reflector. Under the action of the driver mechanism, the first reflector may make the light beam scan the detection range in the vertical direction by stepping swing. Exemplarily, the reflector 21 may include a reflector with a larger area, or may include a micro-electro-mechanical system (MEMS) vibration mirror with a very small area, etc., which is not limited here.

The shape of the first reflector may be designed to be any suitable shape according to the shape of the light spot or the arrangement. Exemplarily, the shape of the first reflector may be any suitable shape such as an ellipse, a square, etc. Therefore, the optical path design may be satisfied and the waste of materials may be reduced as much as possible, thereby reducing costs.

In one embodiment, in the stepping swing, the first reflector may maintain the current attitude for a period of time (i.e., remain stationary for a period of time) after swinging for a step length, and then swing for the next step length after this period of time. The stepping swing may be realized by a driver mechanism, such as a step motor.

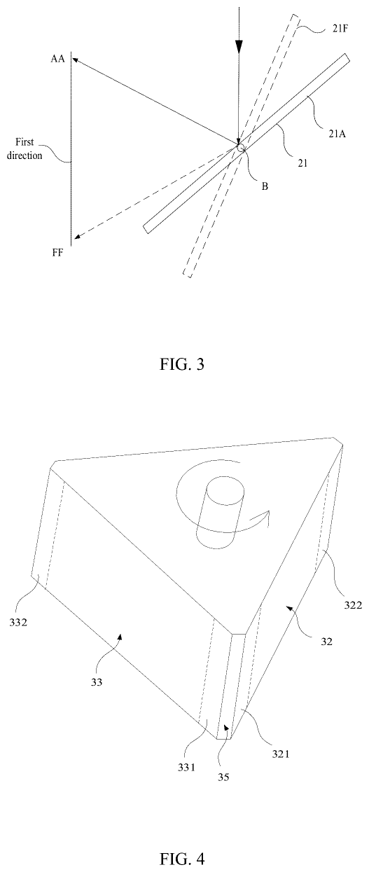

In one embodiment, as shown in FIG. 2 and FIG. 3, the first reflection assembly 20 includes a first reflector 21, and the first reflector 21 may swing along the axis B as the swing axis under the action of the driver mechanism 22. In FIG. 3, the solid-line box and the dotted-line box respectively represent two different attitudes of the first reflector 21. Under the action of the driver mechanism 22, the first reflector 21 may swing from the first attitude 21A to the second attitude 21B by at least one step length with the axis B as the swing axis. When the incident light path of the light pulse incident on the first reflector 21 remains stationary, the first reflector 21 may swing from the first attitude to the second attitude 21B. In the first attitude 21A, the light pulse sequence reaches the upper end AA of the scanning range. And, in the second attitude 21F, the light pulse reaches the lower end FF of the scanning range. In the process of swinging from the first attitude 21A to the second attitude 21F, the light pulse reaches the lower end FF of the scanning range from the upper end AA of the scanning range along the first direction. The scanning range AA-FF constitutes the FOV of the detection device in the first direction.

In one embodiment, when the first reflector is swinging in a step manner, the first reflector may swing from the first attitude to the second attitude through multiple steps, and then swing from the second attitude to the first attitude through one step. When the first reflector swings back from the second attitude to the first attitude, the first reflector may swing in a clockwise direction or in a counterclockwise direction.

In one embodiment, the timing of the light source emitting light pulses may be coordinated with the first reflector. For example, the light source may emit light pulses during the process of the first reflector swinging from the first attitude to the second attitude, and may not emit a sequence of light pulses during the process of the first reflector swinging from the second attitude to the first attitude.

The first reflector may swing from the first attitude to the second attitude through a plurality of steps, and the first reflector may remain stationary for a period of time at each swing of one step. In one embodiment, during the process of the first reflector swinging from the first attitude to the second attitude, the light source may emit a light pulse during the period when the first reflector remains stationary, and may not emit a light pulse during the period when the first reflector swings.

In one embodiment, the second reflection assembly may include a second reflector and a third reflector, and both the second reflector and the third reflector may scan the detection range in the horizontal direction by continuous rotation.

In one embodiment, the second reflection assembly may be connected to a rotation motor and realize continuous rotation under the drive of the rotation motor. In the continuous rotation, that is, when the rotation of the second reflector is continuous, the continuous rotation may be a uniform rotation or a variable speed rotation.

In some other embodiments, a plurality of reflectors may be set on the second reflection assembly, such as three, four, five, six, etc.

In one embodiment shown in FIG. 2, the second reflection assembly 30 includes a second reflector 32 and a third reflector 33. The second reflector 32 and the third reflector 33 are two reflectors respectively arranged at the second reflection assembly 30. The second reflector 32 and the third reflector 33 constitute two reflection surfaces of the second reflection assembly 30. Under the action of the driver mechanism 31, the second reflection assembly 30 may be able to rotate along the rotation axis R. When the second reflection assembly 30 rotates, the second reflector 32 and the third reflector 33 may be rotated to the optical path in sequence to reflect the light beam on the optical path. Since the second reflection assembly 30 is continuously rotating, after the light beam hits the second reflector 32, the light beam may be emitted at different angles along the second direction. Then, after the light beam hits the third reflector 33, the light beam may also be emitted at different angles along the second direction to achieve scanning of the detection range in the second direction. In one embodiment, as shown in FIG. 2, the second direction is a horizontal direction.

In one embodiment, as shown in FIG. 4, there is a junction area 35 between the second reflector 32 and the third reflector 33, and the second reflector 32 and the third reflector 33 are both connected to the junction area 35. The second reflector 32, the junction area 35 and the third reflector 33 are sequentially arranged along the rotation direction of the second reflection assembly 30. When the second reflection assembly 30 rotates, the second reflector 32, the junction area 35 and the third reflector 33 are sequentially rotated to the optical path of the light pulse sequence. In one embodiment, when the junction area 35 rotates to the optical path, the light beam may not be able to be emitted normally, and a black vision period may occur at this time. In one case, when the edge areas 321 or 322 of the second reflector 32, or the edge areas 331 or 332 of the third reflector 33 rotates to the optical path, because of the excessive reflection angle of the edge areas, the light beam may also not be able to be emitted normally, and a black vision period may also occur at this time. In one case, when the reflective surface closest to the optical path is roughly parallel to the optical path, a black vision period may also occur. In contrast, in other time periods, the light beam may be normally reflected by the second reflector or the third reflector and emitted normally, which is called the white vision period.

In one embodiment, the first reflector may swing during the black vision period and stop swinging during the white vision period. Correspondingly, the light source may emit a sequence of light pulses during the period when the first reflector remains stationary in the process of the first reflector swinging from the first attitude to the second attitude, and may not emit a sequence of light pulses during the period when the first reflector swings. In this way, as described above, the first reflector may allow the light pulses to be emitted at different angles in the first direction such as the vertical direction when swinging. Therefore, in the white vision period, since the first reflector stops swinging and only the second reflection assembly changes the emission direction of the light pulses, the light pulses may be scanned along the second direction such as the horizontal direction.

In one embodiment, when scanning the detection range by line-by-line scanning, the first reflector may continuously swing from the first attitude to the second attitude through multiple steps, and then swing from the second attitude to the first attitude through one step, and the second reflector may rotate continuously. In the process of the first reflector swinging from the first attitude to the second attitude through multiple steps, the first reflector may enter a stationary period after swinging for one step, and the light source may emit a sequence of light pulses during the static period of the first reflector. Since the second reflection assembly is still rotating continuously during the static period of the first reflector, different light beams may be emitted at different horizontal angles after being reflected by the second reflection assembly, such that the horizontal point cloud row may be scanned at the current height. After the static period ends, the first reflector may swing for the next step to change the vertical emission angle of the light beam, such that the point cloud row at the next height may be scanned during the static period. This process may be repeated. When the first reflector swings to the second attitude and passes through the static period, the point cloud row of the last height of the currently scanned point cloud frame may be scanned, and the first reflector may swing back to the first attitude through one step to start the line-by-line scanning of the next frame of point cloud.

The commonly used LiDARs in the industry are usually multi-line scanning LiDARs, and the common ones are 16, 32, 40, or 64 lines. A multi-line scanning LiDAR is able to obtain multiple laser scanning lines through scanning, and there are as many point cloud rows as the laser scanning lines. In the present disclosure, for the convenience of understanding, the multiple laser scanning lines that can be obtained by scanning at a height by a multi-line scanning LiDAR are regarded as one point cloud row. That is, the multi-line scanning LiDAR is treated as a single-line scanning LiDAR, i.e., what is obtained in scanning at a height is treated as one point cloud row.

In one embodiment, as shown in FIG. 5 which is a schematic diagram of a point cloud frame, the detection device may scan the detection range in a line-by-line scanning manner, and the point cloud frame scanned within a frame duration may include multiple point cloud rows. When the first reflector is in the first attitude, the light pulse may reach the upper end of the scanning range, such that the point cloud row AA is obtained. And then, the first reflector may swing for the next step, such that the emission angle of the light beam in the vertical direction changes and the point cloud row at the next height is scanned during the static period of the first reflector, thereby obtaining the point cloud row BB. The process may be repeated to obtain the point cloud row CC, the point cloud row DD, and the point cloud row EE in turn, until the first reflector swings to the second attitude and the light pulse reaches the lower end of the scanning range to obtained the point cloud row FF.

Usually, it may be needed to control the mirror directions of the second reflector and the third reflector to be consistent, such that the angles and directions of the light beam after being reflected by the second reflector are consistent with the angles and directions of the light beam after being reflected by the third reflector, and the shape of the point cloud distribution obtained by reflection by the second reflector is consistent with the shape of the point cloud distribution obtained by reflection by the third reflector. Therefore, when the second reflection assembly rotates continuously, the uniformly point cloud line distribution may be obtained. As shown in FIG. 5, because the mirror directions of the second reflector and the third reflector are consistent, when the second reflection assembly rotates, the light pulse may always be emitted at different angles along the second direction, such that the point cloud distribution is uniform in the second direction.

In some cases, because of the manufacturing tolerance or the deformation caused during use of the second reflection assembly, the mirror directions of the second reflector and the third reflector may be different, and the light beam may not always maintain the same reflection angle and direction when passing through the second reflector and the third reflector. For example, one of the second reflector or the third reflector may be able to maintain rotation around the vertical axis during rotation. For the other of the second reflector or the third reflector, because of tolerance in installation with the previous one, or the deformation of the second reflection assembly during the factory process, the use process, etc., an uneven mirror surface with an angle with the vertical direction may appear. Therefore, during rotation, the mirror surfaces of the second reflector and the third reflector may have different angles with the vertical direction, and the reflection angle and direction of the light beam when passing through the second reflector may be different from the reflection angle and direction of the light beam when passing through the third reflector, which is manifested in the uneven distribution of the point cloud. The point cloud may be densely distributed in some scanning ranges, while there may be holes in the point cloud in some other scanning ranges. Therefore, the point cloud distribution may be uneven.

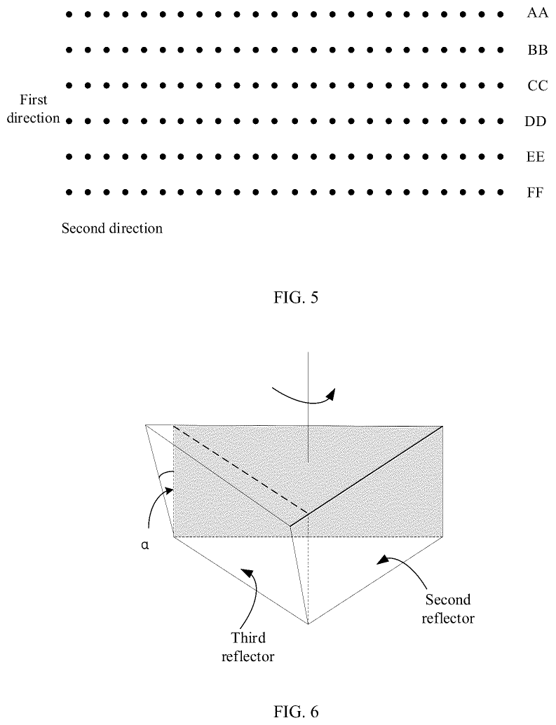

In one embodiment, as shown in FIG. 6, the angle between the second reflector and the vertical direction is 0. The third reflector is tilted, and the angle between the third reflector and the vertical direction is α, and α is greater than 0. Therefore, when performing line-by-line scanning, a horizontally incident light beam may be emitted in a horizontal direction when passing through the second reflector, while a horizontally incident light beam may be emitted in other directions when passing through the third reflector. Therefore, in terms of point cloud distribution, the point cloud row obtained by scanning the second reflector and the point cloud row obtained by scanning the third reflector may have different angles, and the point cloud row obtained by scanning the third reflector may deviate from the vertical direction, thereby deviating from the desired horizontal direction.

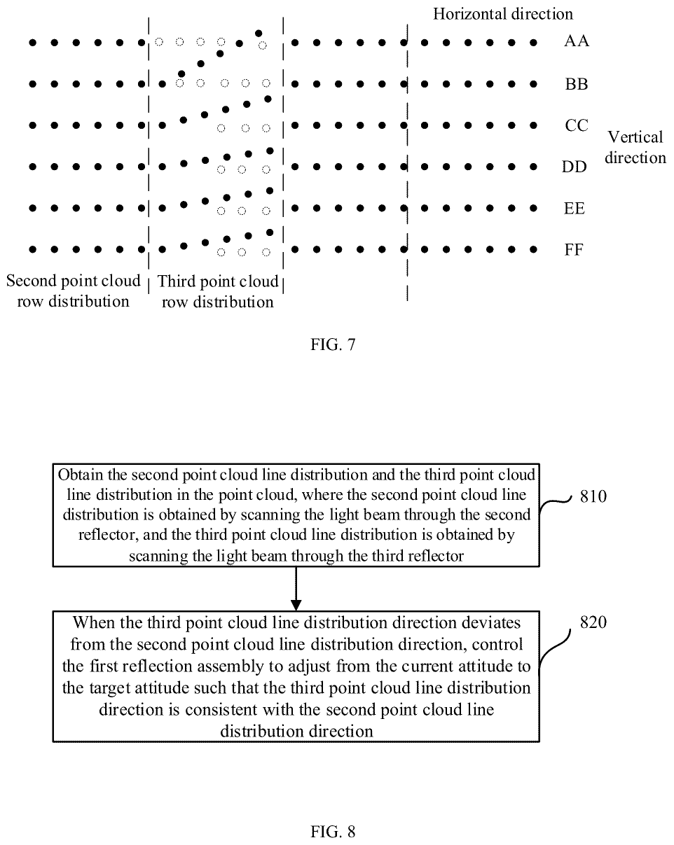

As shown in FIG. 7, which is a point cloud diagram obtained by scanning the first reflection assembly and the second reflection assembly shown in FIG. 6. in the point cloud frame shown in FIG. 7, the point cloud rows obtained by reflection by the second reflector are called the second point cloud rows, and the point cloud rows obtained by reflection by the third reflector are called the third point cloud rows. The hollow origin indicates the expected point cloud distribution when the second reflection assembly works normally, that is, the second point cloud rows and the third point cloud rows may be distributed in the horizontal direction. The solid origin indicates the actual point cloud distribution. In FIG. 7, since the second reflector is placed vertically, the second point cloud rows are distributed in the horizontal direction. Since the third reflector is tilted and there is an angle with the vertical direction, the third point cloud rows deviate from the horizontal direction. In one case, the upper part of the third reflector deviates further from the vertical direction than the lower part. Therefore, in the point cloud distribution, the upper part of the third point cloud rows deviates from the horizontal direction at a larger angle, and the deviation is more obvious. Since the second reflection assembly is rotating continuously, the point cloud rows in the detection range are discontinuous in the horizontal direction, and the point cloud is densely distributed in some scanning ranges, while the point cloud may have holes in some other scanning ranges, such as the area where the hollow origin is located in FIG. 7. The point cloud distribution may be uneven, and the expected point cloud distribution cannot be obtained.

In one embodiment shown in FIG. 8, at 810, obtaining the distribution information of the point cloud includes: obtaining a second point cloud line distribution and a third point cloud line distribution in the point cloud. The second point cloud line distribution may be obtained by scanning the light beam through the second reflector, and the third point cloud line distribution may be obtained by scanning the light beam through the third reflector. Correspondingly, at 820, it is determined whether the point cloud line distribution in the point cloud is along the second direction. When the point cloud line distribution of the point cloud deviates from the second direction, the first reflection assembly may be controlled to adjust from the current attitude to the target attitude to correct the point cloud line distribution in the point cloud to the second direction. S802 may include: when the direction of the third point cloud line distribution deviates from the direction of the second point cloud line distribution, the first reflection assembly may be controlled to adjust from the current attitude to the target attitude to make the third point cloud line distribution consistent with the direction of the second point cloud line distribution.

In another embodiment, the direction of the third point cloud line distribution may also be taken as the desired direction, and when the direction of the second point cloud line distribution deviates from the direction of the third point cloud line distribution, the first reflection assembly may be controlled to adjust from the current attitude to the target attitude, such that the direction of the second point cloud line distribution is consistent with the direction of the third point cloud line distribution.

In one embodiment, whether the direction of the third point cloud line distribution deviates from the direction of the second point cloud line distribution may be judged by determining whether there is an angle difference between the angle of the third point cloud line distribution and the angle of the second point cloud line distribution. For example, when the second point cloud line distribution is along the horizontal direction and the third point cloud line distribution has an angle with the horizontal direction, it may be considered that the direction of the third point cloud line distribution deviates from the direction of the second point cloud line distribution.

In one embodiment, whether the direction of the third point cloud line distribution deviates from the direction of the second point cloud line distribution may be judged by determining whether the angle difference between the third point cloud row and the second point cloud row exceeds a preset threshold. For example, when there is a first angle between the second point cloud rows and the horizontal direction, and there is a second angle between the third point cloud rows and the horizontal direction, and the difference between the first angle and the second angle meets the preset threshold, it may be considered that the direction of the third point cloud line distribution deviates from the direction of the second point cloud line distribution.

The threshold value may include 0.5°, 1°, 2°, 5°, 10°, 15°, or any value between any two values. The value of the preset threshold may be adjusted according to the sensitivity of the control of the first reflection assembly and the uniformity of the point cloud distribution. When setting the threshold value, a higher threshold value may mean that the first reflection assembly does not need to be immediately controlled to adjust from the current attitude to the target attitude to adjust the reflection angle of the light pulse when the third point cloud line distribution deviates from the second point cloud line distribution. This may avoid frequent swinging of the first reflection assembly, thereby reducing the control accuracy requirements for the first reflection assembly, improving the life of the first reflection assembly and reducing the power consumption of the first reflection assembly. A lower threshold value may improve the accuracy of the first reflection assembly. When the third point cloud line distribution deviates from the second point cloud line distribution, the first reflection assembly may be immediately controlled to adjust from the current attitude to the target attitude to adjust the reflection angle of the light pulse. Therefore, the third point cloud row may be immediately adjusted to the direction of the second point cloud line distribution, such that the point cloud rows are more continuous and the point cloud distribution is more uniform.

In one embodiment, the second reflection assembly may include multiple reflectors, for example, may further include a fourth reflector. The fourth reflector, like the second reflector and the third reflector, may continuously rotate to make the light beam scan the detection range in the horizontal direction.

In one embodiment shown in FIG. 2, the second reflector 32, the third reflector 33, and the fourth reflector 34 are three reflectors respectively arranged at the second reflection assembly. When the second reflection assembly 30 rotates, the second reflector 32, the third reflector 33, and the fourth reflector 34 may be rotated to the optical path in sequence. Therefore, the point cloud information obtained includes the second point cloud line distribution, the third point cloud line distribution, and the fourth point cloud line distribution. The fourth point cloud information may be obtained by scanning the light pulse through the fourth reflector.

The fourth reflector 34 in the above embodiment is not necessarily adjacent to the second reflector 32 or the third reflector 33, but is only used to distinguish the second reflector 32 and the third reflector 33 in terms of name, that is, there may be several reflectors between the second reflector 32 and the third reflector 33, and there may also be several reflectors between the third reflector 32 and the fourth reflector 34. It is just that when the second reflection assembly 30 rotates, from the order of rotation, the light pulse may be reflected by the second reflector 32, the third reflector 33, and the fourth reflector 34 in turn. Therefore, in the obtained point cloud information, the distribution range of the fourth point cloud rows may be closer to the distribution range of the third point cloud rows than the distribution range of the second point cloud rows.

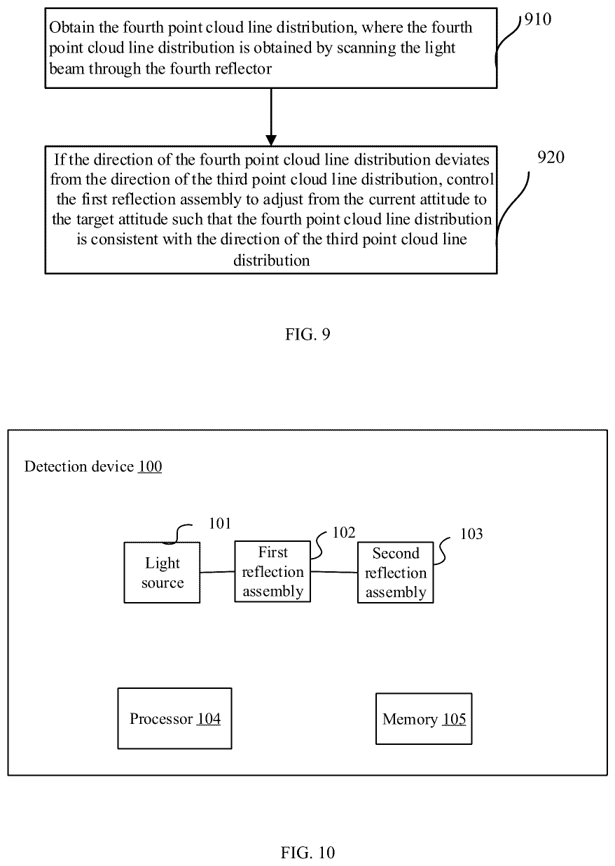

Correspondingly, in the control method, as shown in FIG. 9, at 910, obtaining the distribution information of the point cloud may include, in addition to obtaining the second point cloud line distribution and the third point cloud line distribution in the point cloud, obtaining the fourth point cloud line distribution. At 920, it is determined whether the point cloud line distribution in the point cloud is along the second direction. When the point cloud line distribution of the point cloud deviates from the second direction, the first reflection assembly may be controlled to adjust from the current attitude to the target attitude to correct the point cloud line distribution in the point cloud to the second direction. 920 may include: when the direction of the fourth point cloud line distribution deviates from the direction of the third point cloud line distribution, the first reflection assembly may be controlled to adjust from the current attitude to the target attitude such that the fourth point cloud line distribution is consistent with the direction of the third point cloud line distribution.

Although the second point cloud line distribution is in the expected direction, the third point cloud line distribution range may be closer to the fourth point cloud line distribution range. Taking the direction of the third point cloud line distribution as the basis for judgment, when the direction of the fourth point cloud line distribution deviates from the direction of the third point cloud line distribution, it may be possible to more quickly identify whether the direction of the fourth point cloud line distribution deviates. This is because, even if the angle difference between the fourth point cloud line distribution and the third point cloud line distribution is very small and does not exceed the threshold, that is, the direction of the fourth point cloud line distribution does not deviate significantly, but when the fourth point cloud line distribution is compared with the second point cloud line distribution farther away, because of the accumulation of errors, in some cases, the angle difference between the fourth point cloud line distribution and the second point cloud row may exceed the threshold, and it may be mistakenly believed that the fourth point cloud line distribution direction deviates significantly from the second point cloud line distribution, thereby activating the first reflection assembly to start swinging. Obviously, this may not be friendly to the first reflection assembly. On the other hand, when the direction of the fourth point cloud line distribution is directly adjusted to the direction of the second point cloud line distribution, there may be an obvious jump in the distribution of the entire point cloud. By adjusting the direction of the fourth point cloud line distribution to the direction of the third point cloud line distribution and adjusting the direction of the third point cloud line distribution to be consistent with the direction of the second point cloud line distribution, in the distribution of the entire point cloud, the distribution between the second point cloud rows, the third point cloud rows, and the fourth point cloud rows may have a gradual transition rather than a sudden change or jump. The continuity of the point cloud may be maintained, thereby avoiding the appearance of a partial “vacuum” in the entire point cloud, which is conducive to improving the uniformity of the point cloud distribution.

The point cloud may be sampled to obtain the point cloud line distribution in the point cloud. In this way, the requirements for the point cloud information acquisition device may be reduced and the power consumption may be reduced. In some embodiments, the point cloud may be sampled according to a preset time interval, or the rotation of the first reflection assembly or the second reflection assembly may be controlled and the point cloud may be sampled when the first reflection assembly or the second reflection assembly is in a preset attitude, such as when the first reflection assembly or the second reflection assembly is in a preset position, or a preset angle.

In one embodiment, during the period when the first reflector is stationary, the point cloud may be sampled to obtain the point cloud line distribution in the point cloud. Since the distribution direction of the point cloud rows is completely affected by the second reflection assembly during the period when the first reflector is stationary, when the point cloud line distribution deviates in direction during this period, it may be considered that the second reflection assembly is abnormal.

In the above embodiment, during the period when the first reflector is stationary, the point cloud may be sampled to obtain the point cloud line distribution in the point cloud. During the time period when the first reflector is stationary, the first reflector may be controlled from the current stationary state to the rotating state, to adjust from the current attitude to the target attitude, and the light pulse may be reflected by the first reflector in the target attitude and reach the second reflection assembly, such that the emission direction of the light pulse may be along the second direction.

In another embodiment, during the time period when the first reflector is stationary, the point cloud may be sampled to obtain the point cloud line distribution in the point cloud. During the time period when the first reflector is swinging, the first reflector may be controlled to adjust from the current attitude to the target attitude. For example, the first reflector may swing to the first angle before stopping the swing. The driver mechanism may be controlled to make the first reflector swing directly to the second angle and then stop swinging. In this way, when the first reflector is stationary, the light pulse may be reflected by the first reflector in the second angle and reach the second reflection assembly, such that the emission direction of the light pulse may be along the second direction.

In the present disclosure, the detection device may include a first reflection assembly and a second reflection assembly. The first reflection assembly may make the light beam scan the detection range in the vertical direction by stepping swing, and the second reflection assembly may make the light beam scan the detection range in the horizontal direction by continuous rotation. Since the light beam needs to pass through the first reflection assembly and the second reflection assembly, it may be needed to control the swing period of the first reflection assembly and the second reflection assembly, such that the first reflection assembly is at a specific starting position at the beginning of each swing period and the first reflection assembly is at a specific ending position at the end of each swing period. In this way, it may be ensured that each row in the obtained point cloud rows has the same scanning starting position and scanning ending position at each scanning. After scanning line by line, in a point cloud frame, each point cloud row may have the same starting position and ending position. The problem that the point cloud distribution is discontinuous in the point cloud frame and “vacuum” appears in some areas because of different starting positions or ending positions of each point cloud row after scanning line by line resulted by the period problem of the first reflection assembly and the second reflection assembly, may be avoided. Alternatively, the problem that the starting positions of the point cloud rows are not corresponding to a same position in the scanning range resulting in a decrease in the point cloud density at position, may be avoided.

The control method of the detection device provided in the embodiments of the present disclosure may solve the point cloud unevenness problem caused by the periodicity problem of the first reflection assembly and the second reflection assembly.

In one embodiment, during the process of the first reflector swinging from the first attitude to the second attitude through multiple steps and then swinging from the second attitude to the first attitude through one step by stepping swing, each time the first reflector is in the first attitude, the light source may pass through the same position of the second reflector to continuously scan the detection range in the horizontal direction. Therefore, each time the first reflector is in the first attitude, the light source may be reflected from the same position of the second reflector, ensuring that each point cloud line has the same starting position.

In one embodiment, the first reflector may be reset after a single frame duration, and within the single frame duration, the first reflector may swing from the first attitude to the second attitude through multiple steps, and then swing from the second attitude to the first attitude through one step. That is, the first reflector may always swing from the first attitude to the second attitude, and then from the second attitude to the first attitude, as a swing cycle of the first reflector. At the end of one swing cycle, the first reflector may be controlled to be in a reset state, that is, in the first attitude. In this way, it may be ensured that the first reflector is always in the first attitude at the beginning of the cycle each time.

In some cases, the rotation speed of the second reflection assembly may be relatively fast, and the reset time left for the first reflector may be very short. The first reflector may be controlled to be reset after every two frame durations. Within the odd frame durations, the first reflector may swing from the first attitude to the second attitude through multiple steps. And, within the even frame durations, the first reflector may swing from the second attitude to the first attitude through multiple steps. That is, the first reflector may be reset after two frame durations. The odd frame duration may correspond to the time from the first attitude to the second attitude through multiple steps, and the even frame duration may correspond to the time from the second attitude to the first attitude through multiple steps, and the two frame durations constitute a swing cycle of the first reflector. In one odd frame, after the first reflection assembly swings from the first attitude to the second attitude, the first reflection assembly may not swing from the second attitude to the first attitude in one step, but still swing from the second attitude to the first attitude through multiple steps in the even frame through stepping swing. Under the condition that the step lengths of the odd frame and the step lengths of the even frame are controlled to be symmetrical, the effect of swinging from the second attitude to the first attitude through multiple steps in the even frame through stepping swing may be similar to the effect of the first reflection assembly swinging from the first attitude to the second attitude in the odd frame. For example, in the odd frames, the scanning range may be scanned from the upper end to the lower end, and in the even frames, the scanning range may be scanned from the lower end to the upper end. In the point cloud distribution, there may be no abnormality due to the different swing directions of the first reflector in odd and even frames.

The control method provided in the embodiments of the present disclosure may be applied to the detection device itself. For example, the detection device may include a processor and a memory. When the processor executes a computer program stored in the memory, the control method provided in the embodiments of the present disclosure may be executed.

In some other embodiments, the control method provided in the embodiments of the present disclosure may also be applied to a processing device. The processing device may be another device that is independent of the detection device. The processing device may be connected to the detection device and may control the detection device by executing the control method provided in the embodiments of the present disclosure. In one example, the processing device may be a control system of a movable platform, that is, the movable platform may control the detection device carried by the movable platform by executing the control method provided in the embodiments of the present disclosure.

Another aspect of the present disclosure provides a detection device. As shown in FIG. 10 which is a schematic structural diagram of a detection device consistent with the present disclosure, in one embodiment, the detection device 100 includes a light source 101, a first reflection assembly 102, a second reflection assembly 103, at least one processor 104, and at least one memory 105 having at least one computer program stored therein. The light source 101 may be used to emit a sequence of light pulses. The first reflection assembly 101 and the second reflection assembly 102 may be used to enable the light beam emitted by the light source 101 to scan in a first direction and a second direction respectively to obtain a point cloud within a detection range.

When the at least one processor executes the at least one computer program, the at least one processor may be configured to:
obtain distribution information of a point cloud;
determine whether the point cloud line distribution in the point cloud is along the second direction; and
if the point cloud line distribution of the point cloud deviates from the second direction, control the first reflection assembly to adjust from a current attitude to a target attitude, to correct the point cloud line distribution in the point cloud to the second direction.

In one embodiment, the first reflection assembly may include a first reflector, the first direction may be a vertical direction, and the first reflector may make the light beam scan the detection range in the vertical direction by stepping swing. The second reflection assembly may include a second reflector and a third reflector, the second direction may be a horizontal direction, and the second reflector and the third reflector may make the light beam scan the detection range in the horizontal direction by continuous rotation.

In one embodiment, when acquiring the distribution information of the point cloud, the at least one processor may obtain the second point cloud line distribution and the third point cloud line distribution in the point cloud. The second point cloud line distribution may be obtained by scanning the light beam through the second reflector, and the third point cloud line distribution may be obtained by scanning the light beam through the third reflector.

In one embodiment, when the direction of the third point cloud line distribution deviates from the direction of the second point cloud line distribution, the at least one processor may control the first reflection assembly to adjust from the current attitude to the target attitude such that the third point cloud line distribution is consistent with the direction of the second point cloud line distribution.

In one embodiment, when there is an angle difference between the third point cloud line distribution and the second point cloud line distribution, the at least one processor may control the first reflection assembly to adjust from the current attitude to the target attitude.

In one embodiment, when the angle difference between the third point cloud line distribution and the second point cloud line distribution exceeds a preset threshold, the at least one processor may control the first reflection assembly to adjust from the current attitude to the target attitude such that the angle difference between the third point cloud line distribution and the second point cloud line distribution meets the preset threshold.

In one embodiment, the second reflection assembly may further include a fourth reflector, and the distribution information of the point cloud may further include a fourth point cloud line distribution. The fourth point cloud line distribution may be obtained by scanning the light beam through the fourth reflector.

In one embodiment, when the direction of the fourth point cloud line distribution deviates from the direction of the third point cloud line distribution, the at least one processor may control the first reflection assembly to adjust from the current attitude to the target attitude such that the fourth point cloud line distribution may be consistent with the direction of the third point cloud line distribution.

In one embodiment, the at least one processor may sample the point cloud to obtain the point cloud line distribution in the point cloud.

In one embodiment, the second reflection assembly may be driven by a rotary motor to achieve continuous rotation.

In one embodiment, the first reflector may be driven by a step motor to achieve stepping swing.

In one embodiment, the first reflector may swing from the first attitude to the second attitude through multiple steps, and then swing from the second attitude to the first attitude through one step.

In one embodiment, the light source may emit a sequence of light pulses during the swing of the first reflector from the first attitude to the second attitude, and may not emit a sequence of light pulses during the swing of the first reflector from the second attitude to the first attitude.

In one embodiment, the light source may emit a sequence of light pulses during a period when the first reflector is stationary during the process of the first reflector swinging from the first attitude to the second attitude.

In one embodiment, during the period when the first reflector is stationary, the point cloud may be sampled to obtain the point cloud line distribution of the point cloud.

In one embodiment, during the swinging process of the first reflector from the first attitude to the second attitude, after the first reflector swings one step, the second reflection assembly may continuously rotate to scan the light beam in the horizontal direction during the period when the first reflector is stationary.

In one embodiment, each time the first reflector is in the first attitude, the light source may make the light beam continuously scan the detection range in the horizontal direction through the same position of the second reflector.

In one embodiment, the first reflector may be reset after a single frame duration, and the first reflector may swing from the first attitude to the second attitude through multiple steps within the single frame duration, and then swing from the second attitude to the first attitude through one step.

In one embodiment, the first reflector may be reset after every two frame durations. In the odd frame durations, the first reflector may swing from the first attitude to the second attitude through multiple steps. In the even frame duration, the first reflector may swing from the second attitude to the first attitude through multiple steps

For the details of the detection device, the references may be made to the previous embodiments about the control method, and will not be repeated here.

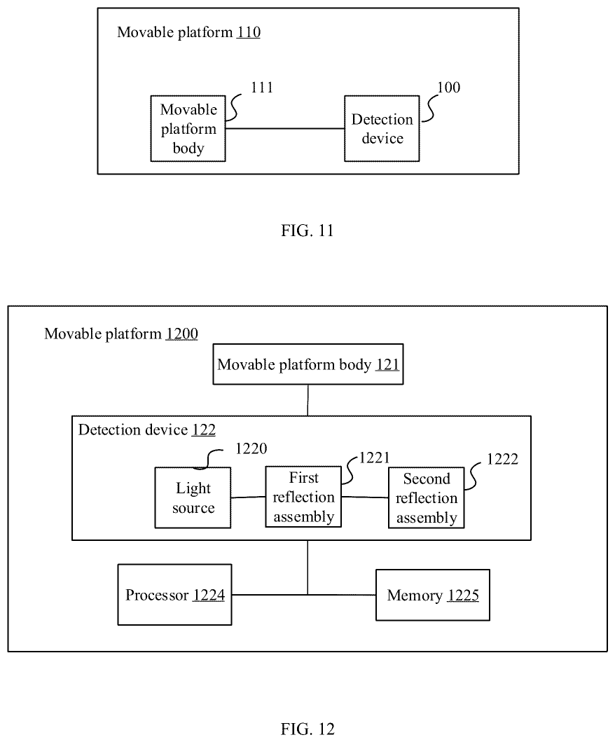

Another aspect of the present disclosure also provides a movable platform. As shown in FIG. 11 which is a schematic structural diagram of a movable platform consistent with the present disclosure, in one embodiment, the movable platform may include: a movable platform body 111 and a detection device 100 mounted at the movable platform body 111. The detection device 100 may be any detection device provided by various embodiments of the present disclosure.

Another aspect of the present disclosure also provides a movable platform. As shown in FIG. 12 which is a schematic structural diagram of a movable platform 1200 consistent with the present disclosure, in one embodiment, the movable platform 1200 may include:
a movable platform body 121;
a detection device 122 mounted at the movable platform body 121, where the detection device 122 includes a light source 1220 used to emit a sequence of light pulses, a first reflection assembly 1221 and a second reflection assembly 1222 used to enable the light beam emitted by the light source to scan in a first direction and a second direction respectively to obtain a point cloud within the detection range;
at least one processor 1224 and at least one memory 1225 having at least one computer program stored therein.

When the at least one processor 1224 executes the computer program, any control method provided by various embodiments of the present disclosure may be implemented.

In some embodiments, the movable platform may include at least one of an unmanned aerial vehicle, a car, a remote-controlled car, a robot, or a camera. When the distance measuring device is applied to an unmanned aerial vehicle, the movable platform body may be the body of the unmanned aerial vehicle. When the distance measuring device is applied to a car, the movable platform body may be the body of the car. The car may be an automatic driving car or a semi-automatic driving car, which is not limited here. When the distance measuring device is applied to a remote-controlled car, the movable platform body may be the body of the remote-controlled car. When the distance measuring device is applied to a robot, the movable platform body may be the robot. When the distance measuring device is applied to a camera, the movable platform body may be the body of the camera. The movable platform may further include a power system for driving the movable platform body to move. For example, when the movable platform is a vehicle, the power system may be an engine inside the vehicle, which is not listed here one by one.

Another aspect of the present disclosure provides a computer-readable storage medium. The computer-readable storage medium may be configured to store at least one computer program. When the at least one computer program is executed by at least one processor, a device where the at least one processor is located may implement any control method provided by various embodiments of the present disclosure.

The embodiments of the present disclosure may take the form of a computer program product implemented on one or more storage media (including but not limited to disk storage, CD-ROM, optical storage, etc.) containing program code. Computer-usable storage media include permanent and non-permanent, removable and non-removable media, and information storage can be implemented by any method or technology. Information can be a computer-readable instruction, a data structure, a module of a program, or other data. Examples of computer storage media include but are not limited to: phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disk read-only memory (CD-ROM), digital versatile disk (DVD) or other optical storage, magnetic cassettes, magnetic tape magnetic disk storage or other magnetic storage devices or any other non-transmission media that can be used to store information that can be accessed by a computing device.

The units described as separate components may or may not be physically separated, and the components shown as units may or may not be physical units, that is, they may be located in one place, or they may be distributed on multiple network units. Some or all of the units may be selected according to actual needs to achieve the purpose of the present disclosure. In addition, the functional units in the various embodiments of the present disclosure may be integrated in a processing unit, or each unit may exist physically separately, or two or more units may be integrated in one unit. The above-mentioned integrated units may be implemented in the form of hardware or in the form of software functional units.

When the integrated unit is implemented in the form of a software functional unit and sold or used as an independent product, it may be stored in a computer-readable storage medium. Based on this understanding, the technical solution of the present disclosure, in essence, or all or part of the technical solution, may be embodied in the form of a software product, and the computer software product may be stored in a storage medium, including several instructions for a computer processor to execute all or part of the steps of the method described in each embodiment of the present disclosure. The aforementioned storage medium may include: a flash disk, a mobile hard disk, a read-only memory (ROM), a random access memory (RAM), a magnetic hard disk, an optical disk, or other media that can store program code.

In the present disclosure, terms such as “certain embodiments,” “one embodiment,” “some embodiments,” “illustrative embodiments,” “examples,” “specific examples” or “some examples,” mean that a specific feature, structure, material or characteristic described in connection with the embodiments or examples is included in at least one embodiment or example of the present disclosure. In the present disclosure, schematic representations of the above terms do not necessarily refer to the same embodiment or example. Furthermore, the specific features, structures, materials or characteristics described may be combined in any suitable manner in any one or more embodiments or examples.

In this disclosure, relational terms such as “first” and “second” are merely used to distinguish one entity or operation from another, and do not necessarily require or imply any actual relationship or order between these entities or operations. The terms “comprising,” “including,” or any of their other variations are intended to cover non-exclusive inclusivity, so that a process, method, article, or device that includes a series of elements not only includes those elements but also includes other elements not explicitly listed, or elements inherent to such a process, method, article, or device. Unless otherwise specified, an element associated with the statement “comprising a . . . ” does not exclude the presence of additional identical elements in the process, method, article, or device that includes the element.

Various embodiments have been described to illustrate the operation principles and exemplary implementations. Those skilled in the art would understand that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A control method comprising:
obtaining distribution information of a point cloud obtained by a detection device, the detection device including a light source and a first reflection assembly and a second reflection assembly configured to cause a light beam emitted by the light source to scan in a first direction and a second direction, respectively, to obtain the point cloud in a detection range; and
in response to a point cloud line distribution of the point cloud deviating from the second direction, controlling the first reflection assembly to adjust from a current attitude to a target attitude, to correct the point cloud line distribution to the second direction.

2. The method according to claim 1, wherein the first direction is a vertical direction, and the second direction is a horizontal direction.

3. The method according to claim 1, wherein:
the first reflection assembly includes a first reflector, configured to cause the light beam to scan the detection range in the first direction by stepping swing; and
the second reflection assembly includes a second reflector and a third reflector, configured to cause the light beam to scan the detection range in the second direction by continuous rotation.

4. The method according to claim 3, wherein in response to a point cloud line distribution of the point cloud deviating from the second direction, controlling the first reflection assembly to adjust from a current attitude to a target attitude, to correct the point cloud line distribution to the second direction includes:
in response to a direction of a first point cloud line distribution of the point cloud obtained by the light beam scanning after being reflected by the third reflector deviating from a direction of a second point cloud line distribution of the point cloud obtained by the light beam scanning after being reflected by the second reflector, controlling the first reflection assembly to adjust from the current attitude to the target attitude, to cause the direction of the first point cloud line distribution to be consistent with the direction of the second point cloud line distribution.

5. The method according to claim 4, wherein in response to the direction of the first point cloud line distribution deviating from the direction of the second point cloud line distribution, controlling the first reflection assembly to adjust from the current attitude to the target attitude includes:
in response to an angle difference existing between the first point cloud line distribution and the second point cloud line distribution, controlling the first reflection assembly to adjust from the current attitude to the target attitude.

6. The method according to claim 4, wherein in response to the direction of the first point cloud line distribution deviating from the direction of the second point cloud line distribution, controlling the first reflection assembly to adjust from the current attitude to the target attitude, to cause the direction of the first point cloud line distribution to be consistent with the direction of the second point cloud line distribution includes:
in response to an angle difference between the first point cloud line distribution and the second point cloud line distribution exceeding a preset threshold, controlling the first reflection assembly to adjust from the current attitude to the target attitude, to cause the angle difference to meet the preset threshold.

7. The method according to claim 3, wherein the second reflection assembly is driven by a rotation motor to achieve the continuous rotation.

8. The method according to claim 3, wherein the first reflector is driven by a step motor to realize the stepping swing.

9. The method according to claim 3, wherein the light source is configured to emit a sequence of light pulses in a process of the first reflector swinging from a first attitude to a second attitude, and to not emit a sequence of light pulses in a process of the first reflector swinging from the second attitude to the first attitude.

10. The method according to claim 9, wherein the light source is configured to emit the sequence of light pulses during a period in which the first reflector is stationary in the process of the first reflector swinging from the first attitude to the second attitude.

11. The method according to claim 9, further comprising:
during a period in which the first reflector is stationary, sampling the point cloud to obtain the point cloud line distribution in the point cloud.

12. The method according to claim 9, wherein in the process of the first reflector swinging from the first attitude to the second attitude, after the first reflector swings by one step length, the second reflection assembly continuously rotates during a period in which the first reflector is stationary to scan the light beam in the horizontal direction.

13. The method according to claim 9, wherein each time the first reflector is in the first attitude, the light beam passes through a same position at the second reflector to continuously scan the detection range in the horizontal direction.

14. The method according to claim 13, wherein:
the first reflector is reset within a single frame duration; and
within the single frame duration, the first reflector swings from the first attitude to the second attitude through multiple steps, and then swings from the second attitude to the first attitude through one step.

15. A detection device comprising:
a light source configured to emit a sequence of light pulses;
a first reflection assembly and a second reflection assembly, configured to cause a light beam emitted by the light source to scan in a first direction and a second direction, respectively, to obtain a point cloud within a detection range;
at least one processor; and
at least one memory storing at least one computer program that, when executed by the at least one processor, causes the detection device to:
obtain distribution information of the point cloud; and
in response to a point cloud line distribution of the point cloud deviating from the second direction, control the first reflection assembly to adjust from a current attitude to a target attitude, to correct the point cloud line distribution to the second direction.

16. The detection device according to claim 15, wherein the first direction is a vertical direction, and the second direction is a horizontal direction.

17. The detection device according to claim 15, wherein:
the first reflection assembly includes a first reflector, configured to cause the light beam to scan the detection range in the first direction by stepping swing; and
the second reflection assembly includes a second reflector and a third reflector, configured to cause the light beam to scan the detection range in the second direction by continuous rotation.

18. The detection device according to claim 15, wherein the light source is configured to emit the sequence of light pulses in a process of the first reflector swinging from a first attitude to a second attitude, and to not emit a sequence of light pulses in a process of the first reflector swinging from the second attitude to the first attitude.

19. The detection device according to claim 18, wherein the light source is configured to emit the sequence of light pulses during a period in which the first reflector is stationary in the process of the first reflector swinging from the first attitude to the second attitude.

20. A movable platform, comprising:
a movable platform body;
a detection device mounted at the movable platform body and including:
a light source configured to emit a sequence of light pulses; and
a first reflection assembly and a second reflection assembly, configured to cause a light beam emitted by the light source to scan in a first direction and a second direction, respectively, to obtain a point cloud within a detection range;
at least one processor; and
at least one memory storing at least one computer program that, when executed by the at least one processor, causes the detection device to:
obtain distribution information of the point cloud; and
in response to a point cloud line distribution of the point cloud deviating from the second direction, control the first reflection assembly to adjust from a current attitude to a target attitude, to correct the point cloud line distribution to the second direction.
